(19) United States
(12) Patent Application Publication
(10) Pub. No.: US 2026/0055727 A1
(43) Pub. Date: Feb. 26, 2026

(54) GAS HANDLING SYSTEM COMPRISING A TURBOEXPANDER AND METHOD FOR USING THE SYSTEM

(71) Applicant: WELLPOWER TECHNOLOGIES AS, Melhus (NO)

(72) Inventors: Joakim Bjerkmo, Melhus (NO); Daniel Bjerkmo, Melhus (NO)

(73) Assignee: WELLPOWER TECHNOLOGIES AS, Melhus (NO)

(21) Appl. No.: 19/376,379

(22) Filed: Oct. 31, 2025

Related U.S. Application Data
(63) Continuation of application No. PCT/NO2024/050105, filed on May 2, 2024.

(30) Foreign Application Priority Data
May 3, 2023 (NO) 20230516

(51) Int. Cl. F02C 6/18; E21B 43/34; F01D 15/10

(52) U.S. Cl. CPC F02C 6/18; E21B 43/34; F01D 15/10; F05D 2220/76

(57) ABSTRACT

A gas processing plant, wherein the gas processing plant includes a raw wellfluid flow line, a raw wellfluid bypass choke valve, an inlet separator, and an export gas compressor. The gas processing plant includes an energy harvesting assembly including a raw wellfluid knock out drum connected to the raw wellfluid flow line, a turboexpander connected to a generator, and a conduit between the turboexpander and the inlet separator, where the conduit is connected to the inlet separator downstream of the raw wellfluid bypass choke valve. An export gas energy regeneration line is adapted to recycle an export quality gas from downstream the export gas compressor to upstream the turboexpander. Methods for operating the gas processing plant are also provided.

### CROSS REFERENCE TO RELATED APPLICATIONS

This application is a continuation of International Patent Application No. PCT/NO2024/050105, filed May 2, 2024, which claims priority to Norwegian patent application No. 20230516, filed May 3, 2023, the contents of each of which are incorporated by reference herein.

### FIELD OF THE INVENTION

The present invention relates to a gas processing plant. In particular, the invention relates to a gas handling system comprising an assembly for recuperating lost energy. The energy may origin from the pressure of gas from a gas reservoir, heat sources and other pressure/energy sources in the gas processing plant. The invention also relates to a method for recuperating lost energy. This otherwise lost energy from e.g., the gas reservoir is transformed into useful electrical power while controlling flowing pressure from well(s)/flowline(s) in a safe and efficient manner. The electrical power can be used for powering the plant itself or export of electric power to other nearby facilities/grids. The invention also implies other significant positive effects for the gas processing.

### BACKGROUND

Due to an increased focus on reducing CO2 emissions and due to higher energy prices, there is a need for a compact solution that enables recuperation of lost energy from pressure reduction, abundant heat sources and gas recycling in gas processing plants, while controlling the gas flow from reservoir/wells/flowlines in a safe and efficient manner.

It is commonplace for gas to flow from the gas reservoir via wells and flowlines to gas processing plants at a specific pressure, flowrate, and temperature. Gas pressure is commonly reduced from the well and/or flowline via a pressure reducing valve e.g. a choke valve to a certain process plant pressure for subsequent treatment in the gas processing plant. When pressure is reduced in a choke valve, the energy is converted into a no longer useful internal energy that cannot be exploited in any meaningful manner.

The aim of a gas processing plant is to dehydrate the gas and to achieve a hydrocarbon dewpoint to a certain specification set by an export gas pipeline operator. In this process, pressure and temperature in the different gas treatment stages is of importance to obtain the required specification by condensing out heavier hydrocarbons and aqueous liquids from the gas. The condensed hydrocarbon liquid is subsequently conditioned to a certain specification and stored in storage tanks or exported directly by pipeline. Produced water is treated according to local regulations and typically re-leased to sea or injected into the reservoir.

After the gas pressure is reduced by the choke valve, heavy hydrocarbons and water are condensed out of the gas by decreasing gas temperature by coolers and routing the gas through separators and scrubbers. When the gas has passed through the processing plant, the gas is compressed to the export line operation pressure by an export compressor and exported via a pipeline to a gas refinery or an end customer.

The export gas compressor(s) and/or gas re-compressor(s) is/are typically the biggest energy consumer in the gas processing plant and is usually driven by a Brayton cycle gas turbine. It is common to have a Waste Heat Recovery unit (WHRU) on the exhaust of Brayton cycle gas turbine to recuperate heat from the turbine exhaust and transfer this energy to a heating medium to cater for various heating needs in the gas processing plant. There is often an abundance of heat energy from the WHRU in a typical gas processing plant. Such abundant heat energy is wasted, however the heat energy could be transformed into useful energy.

At some time in the gas field life, the production rate will decrease until the export compressor(s) and/or re-compressor(s) is/are required to operate outside its operational envelope. This will result in a serious condition called compressor surge, which may cause a total mechanical breakdown of the compressor within a short time span.

To avoid compressor surge, some of the compressed gas from the compressor(s) may be recycled via an anti-surge or a recycle valve to the upstream side of the compressor(s) to increase the relative gas flowrate through the compressor(s) in order to maintain the compressor(s) within its operational envelope. The recycling intensity increases as the export compressor(s) and/or re-compressor(s) gradually moves further outside its operational envelope as a function of reduced production rate throughout the declining production period of the gas field.

The recycling of compressed gas represents a net energy waste with no or minimal utility for the processing plant and represents a significant CO2 emission source and affiliated economic loss for the field operator.

Due to the reasons mentioned above it will at some time be economically viable to do an extensive re-bundling modification of the compressor(s) to adapt it to its current operating conditions, to avoid gas recycling.

The mentioned re-bundling modification offers a temporary solution to the recycling issue. Nevertheless, with further decline in gas production, the compressor(s) will inevitably at some time operate outside their operational envelope once again. This circumstance will necessitate a recurrence of the previously described gas recycling to avoid compressor surge.

The re-bundling modifications provide a temporary solution to the recycling problem by adjusting the compressor capacity to match the current production rate. However, due to the cost and complexity involved, these modifications do not include adjustments to the compressor driver, typically a Brayton cycle gas turbine. Given that Bray-ton cycle turbines achieve optimal thermal efficiency at maximum relative load, subsequent re-bundling projects will lead to a decrease in the overall efficiency of the com-pressor unit. This inefficiency will result in higher CO2 emissions and accelerated wear on the Brayton cycle turbine, necessitating increased maintenance costs.

Patent document EP 2246574 discloses to use a turboexpander on the anti-surge/re-circulating line downstream the compressor in order to recuperate a portion of the otherwise wasted energy.

Turboexpanders paired with compressors are widely employed in numerous gas processing facilities to manage the dew point in hydrocarbon gas streams. The primary function of these turboexpander-compressor systems is to meet specific dew point specification and enhance the production of hydrocarbon liquids, often referred to as condensate or Natural Gas Liquids (NGLs). This is achieved through the isentropic expansion of gas across the turboexpander, which cools and depressurizes the gas, causing heavier hydrocarbons to condense from the vapor phase. The compressor, directly linked to the turboexpander via a shared power transmission shaft, serves to recover some of the pressure lost during this expansion, providing a cost-effective method for controlling the dew point. Although the compressor, which is driven by the turboexpander, recuperates some of the energy, the system still results in a net loss of pressure energy. This deficit requires additional fuel gas and subsequent increased CO2 emissions due to the power needed for further compression.

In a gas processing plant, seawater is typically pumped from the sea as a cooling medium to refrigerate the gas between the separation stages to its required temperature to obtain the gas specification set by the gas export pipeline operator. This pumping requires large amounts of energy and is typically the biggest electrical power consumer in a gas processing plant.

### SUMMARY

The present disclosure aims to overcome the drawback for recuperating lost energy from pressure and heat sources in a gas processing plant and transform it into useful electrical power while controlling flowing pressure from the reservoir in a safe and efficient manner, where the electrical power can be used for powering the plant itself or export of electric power to other nearby facilities/grids.

The invention has for an object to remedy or to reduce at least one of the drawbacks of the prior art, or at least provide a useful alternative to prior art.

The object is achieved through features, which are specified in the description below and in the claims that follow.

The inlet arrangement must regulate the pressure and flow of the incoming reservoir gas in a safe and efficient manner to avoid process upsets and spurious operation. By decreasing the gas pressure across a gas expansion turbine, hereafter named a turboexpander, it enables recuperation of this otherwise wasted energy into useful rotational mechanical energy. By coupling the turboexpander to a generator, energy in the incoming reservoir gas flow can be converted to electrical energy and thus reducing or even substituting the need for electric power generation typically via Brayton cycle gas turbine(s). In addition to this, the near isentropic expansion of the gas through the turboexpander also results in a larger temperature drop in the gas compared to the isenthalpic Joule-Thompson temperature decline across a conventional choke valve as known in prior art. The higher temperature drop across the turboexpander leads to a reduction in seawater consumption of the processing plant and lowers frictional pressure losses through the processing plant since the gas is cooler and consequently denser. The lower gas temperature leads to a higher condensate production rate, and better gas specification, which may in one embodiment of the invention enable the gas processing plant to export sales quality gas directly to the end consumer without further processing in a midstream gas refinery. The reduced friction losses lead to lower energy consumption in the export gas compressor as the gas pressure at the compressor inlet is higher compared to a conventional gas processing plant.

Alternatively, in another embodiment of the invention it may be more advantageous to operate the gas processing plant at a higher gas pressure, since the lower temperature downstream the turboexpander will promote condensation of hydrocarbon and aqueous liquids, which may enable achievement of the required gas specification at a relatively higher plant operating pressure compared to a conventional gas processing plant. Operating the gas processing plant at a relatively higher gas pressure reduces the pressure difference between the export pipeline and the plant operating pressure, thus significantly lowering the fuel gas consumption and subsequent CO2 emissions of the compressor(s).

Concurrently, if there is a surplus of heat from the Waste Heat Recovery unit (WHRU) or other sources, this previously unutilized thermal energy can be directed to a turboexpander feed gas heater positioned upstream of the turboexpander. This pre-heating process expands the gas, thereby enhancing the energy output potential of the turboexpander. Although it may be necessary to cool the gas downstream of the turboexpander to mitigate the heating effect, a substantial net energy gain is typically realized. Furthermore, heating the gas above the hydrate equilibrium temperature can eliminate the need for MEG/Methanol injection to prevent hydrate formation. Additionally, pre-heating the gas helps maintain the downstream temperature of the turboexpander within safe operational limits, due to pipe specifications or other design constraints. Ultimately, heating the reservoir gas increases the energy potential in the gas stream, resulting in greater power production from the turboexpander. Recycle gas from export compressor(s) and/or re-compressor(s) may be routed upstream of the turboexpander and turboexpander feed gas heater to recuperate energy that is otherwise wasted during start-up procedures which requires plant recycling of gas within the plant. Recycle gas from export compressor(s) and/or re-compressor(s) can be rerouted upstream of the turboexpander and turboexpander feed gas heater to facilitate the energy regeneration from the recycled export gas. This approach allows for the recuperation of energy that would otherwise be lost when these compressors are operated at off-design points. Such operational conditions necessitate the recycling of gas to prevent compressor surge, thereby enhancing overall energy efficiency and reducing CO2 emissions. The recycling intensity increases as the export compressor(s) and/or re-compressor(s) gradually moves further outside its operational envelope as a function of reducing production rate throughout the decline production period.

Embodiments of the present invention may therefore render the need for a costly re-bundling of export compressor(s) and/or re-compressor(s) unnecessary, since the compressor(s) can generate electrical power via the turboexpander with a reasonable efficiency, in combination with reduction in overall gas processing plant energy consumption due to the cooling effect of the isentropic expansion as mentioned above. This functionality potentially enables maintenance on the main power generation turbine without production shutdown by ramping up export and/or re-compressor(s) and increasing the export gas energy regeneration from the turboexpander, in conjunction with the reservoir gas flow and the heat energy recovery functionality. This process can generate adequate electrical power for the gas processing plant, allowing for maintenance or even rendering the main power generator redundant. The latter could be a more energy-efficient solution, particularly when the main power generator operates at a relatively low load.

Brayton cycle gas turbines exhibit variable efficiency across their different fuel gas staging levels, but generally achieve peak thermal efficiency at maximum relative load. Consequently, precise regulation of individual turbine loads is crucial for optimizing energy efficiency. Effective management of these loads can significantly reduce overall fuel gas consumption and the associated CO2 emissions.

With the above-mentioned export gas energy regeneration feature, the export compressor(s) and/or re-compressor(s) can function as an indirect, redundant electrical power generation system via the turboexpander. This provides means for optimizing the net plant energy utility by enabling fine tuning of loads and staging levels between power generating and compressor turbine driver(s) for the specific operational condition. This functionality ensures that embodiments of the invention remains highly beneficial not only during the plateau production period, but throughout the entire production life of the field.

Unlike the well-known turboexpander-compressor dew point control system known in prior art, embodiments of the current invention offer a net positive energy contribution to the gas processing plant. Embodiments of the invention achieve this by replacing the choke valve used for regulating the raw wellfluid stream from the reservoir and converting the otherwise lost pressure energy into useful electrical power. Simultaneously, it retains many of the beneficial features of a dew point control system. Additionally, it provides effective means for recuperating energy that would otherwise be lost from compressor recirculation and utilizes abundant heat sources within the system for power production.

Embodiments of the invention also resolve issues related to the safe and efficient control of well flow in conjunction with a turboexpander. In this system, the turboexpander functions analogously to a choke valve. The generator serves as the actuator, adjusting the conductance of the “valve” by varying the power extraction imposed on the gas stream by the turboexpander. This method allows for precise control over the flow and pressure adjustments necessary for optimal operation. There are several process safety issues concerning the use of a turboexpander as a pressure letdown device. Embodiments of the invention address these process safety issues and proposes solutions that are inherently safe by design.

The reservoir gas that is directed to the turboexpander is routed through an upstream separator and a choke valve with a high capacity on the gas outlet of said upstream separator. The placement of this choke valve on the gas outlet is to enable single phase operation for the choke valve and consequently a strongly reduced erosive potential, where a ductile and non-collapsible material could be applied for the valve trim. This is of importance, since the valve must have a high conductance in order to minimize pressure drop. Preferably a maximum pressure drop should be applied in the turboexpander to maximize power output. Since a non-collapsible, ductile material is chosen for the valve trim and internals, the process safety requirements concerning choke collapse can be disregarded as this is no longer a credible scenario.

All types of turbines should have a fast-acting fuel shut-off valve in order to trip the turbines fuel supply in a critical event like, for example, overspeed. Such shut off valves can be classified as a High Integrity Pressure Protection System (HIPPS) to conform to process safety design requirements regarding inadvertent valve opening of the highly conductive choke valve upstream of the HIPPS.

By using a non-collapsible valve trim and internals in the choke valve in combination with using a HIPPS as a turbine shut off valve and protective system in case of inadvertent valve opening, all requirements regarding process safety upstream of the turboexpander are fulfilled.

Turboexpanders are usually limited to operating at maximum 1-2 weight % liquid in the feed gas and preferably with a drier feed gas. Most gas streams directly from reservoir usually have much higher liquid content, and certainly during start up situations and process upsets. Embodiments of the invention address these issues by presenting a slim-design separator upstream of the turboexpander to condition the gas within the turboexpanders operational limits.

The task of the upstream separator is not to contribute to natural gas dehydration, but rather to re-route liquids contained in the gas at upstream pressure and temperature and thus conditioning the gas to be in accordance with the given turboexpander operational limits. The liquid outlet level control valves must be able to control the liquid level in the upstream separator during normal operation and process upsets, like liquid slugging or cold startups. Therefore, a split range controller is suggested to enable smooth operation with a lower capacity valve during normal processing conditions, and a large valve to enable liquid control during slugging or other process upsets.

A check valve may be mounted downstream of the choke valve to avoid reverse flow when well flow is routed via a bypass choke, and the turboexpander produces power solely by export gas energy regeneration flow from export and/or re-compressor(s).

Embodiments of the invention result in the production of electrical power to the gas processing plant power grid as well as a reduction in energy consumption. Therefore, a substantial reduction in overall fuel gas consumption is obtained, thus reducing CO₂ emissions and increasing overall plant energy utility. The gas that is not consumed as local fuel gas for turbines can be exported, thus expanding the economic viable lifetime of a gas field and lowering operational expenses throughout the field lifetime.

Embodiments of the invention are compact and reliable means for safe and efficient production of electrical energy from sources otherwise wasted in a conventional gas processing plant as described in prior art. Embodiments of the invention are readily available for retrofitting in existing gas processing plants as well as implementation in new developments. For a person skilled in the art, the many variations and possibilities for adaptation to the process conditions will be apparent.

Since Natural gas, Condensate/Natural gas liquids and CO2 are commodities that are individually priced in the future markets at any time, embodiments of the invention dramatically increase the gas processing plants capability to adapt to the current market conditions by giving the skilled operator an optionality in how the invention is operated based on the current market and operational conditions.

In a first aspect the invention relates more particularly to a gas processing plant, wherein the gas processing plant comprises at least:
a raw wellfluid flowline;
a raw wellfluid bypass choke valve;
an inlet separator; and
an export gas compressor.

The gas processing plant comprises an energy harvesting assembly, wherein the energy harvesting assembly comprises:
a raw wellfluid knock out drum connected to the gas flow line;
a turboexpander connected to a generator; and
a conduit between the turboexpander and the inlet separator, wherein the conduit is connected to the raw wellfluid flowline downstream of the raw wellfluid bypass choke valve,
and an export gas energy regeneration line is adapted to recycle an export quality gas from downstream the export gas compressor to upstream of the turboexpander.

In one embodiment the harvesting assembly may comprise fast acting fuel shut-off valves/turbine shut off valve(s) in order to trip the gas flow to the turboexpander to avoid overspeed, for example if a sudden load loss on the generator occurs. The turbine shut off valve(s) may be required in order to trip the gas flow through the turboexpander in case of overpressure in a downstream segment due to, but not limited to, inadvertent valve operation or other process upsets.

The energy harvesting assembly may comprise a turboexpander feed gas heater upstream of the turboexpander. The turboexpander feed gas heater may be fluidly connected to a waste heat recovery unit via a heat circulation loop.

A separated liquid may be contained within the gas/liquid separator. The raw wellfluid knock out drum may be provided with a liquid outlet, and the liquid outlet may be fluidly connected to the raw wellfluid flow line on the downstream side of the turboexpander.

At least one re-compressor may be fluidly connected to a turboexpander feed gas line upstream of the turboexpander.

A turboexpander feed gas regulation valve may be positioned upstream of the turboexpander.

A turboexpander feed gas regulation valve may be positioned between a gas outlet of the raw wellfluid knock out drum and the turboexpander. A check valve may be positioned downstream of the turboexpander feed gas regulation valve.

The gas processing plant may comprise an injection system for injection of mono ethylene glycol, methanol or other suitable compounds for preventing gas hydrate formation in the raw wellfluid flowline. The injection system may comprise an injector downstream of the check valve.

In a second aspect the invention relates more particularly to a method for recuperating energy in a gas processing plant during a declining production period. The method comprises to:
provide the gas processing plant as described herein; and
recycle export quality gas from downstream the export gas compressor to upstream of the turboexpander.

The method may comprise to heat the export quality gas by a turboexpander feed gas heater.

The method may comprise to utilize a recycle gas flow from at least one re-compressor into the turboexpander feed gas line upstream of the turboexpander.

In a third aspect the invention relates more particularly to a method for recuperating energy in a gas processing plant during a plateau production period. The method comprises to:
provide the gas processing plant as described herein;
close a raw wellfluid bypass choke on the raw wellfluid flow line; and
route all well gas through the turboexpander.

The method may comprise to heat the well gas by a turboexpander feed gas heater.

The method may comprise to utilize a recycle gas flow from at least one re-compressor into the turboexpander feed gas line upstream of the turboexpander.

The method may comprise to recycle the gas of export quality from downstream the export gas compressor to upstream of the turboexpander.

An advantage of recycling sufficient volumes of gas from the export compressor(s) and/or the re-compressor(s) to upstream of the turboexpander, is that power production from the turboexpander may be increased to an extent that one or more gas turbine driven generator(s) is/are rendered abundant.

### BRIEF DESCRIPTION OF THE DRAWING

In the following are described examples of preferred embodiments illustrated in the accompanying drawings, wherein:

FIG. 1 is a schematic process diagram showing valves in a conventional inlet gas arrangement;

FIG. 2 is a schematic representation of a gas processing plant according to prior art; and

FIG. 3 is a schematic representation of the invention incorporated into a conventional gas processing plant.

### DETAILED DESCRIPTION OF THE PREFERRED EMBODIMENTS

Any positional indications refer to the position shown in the figures.

In the figures, same or corresponding elements are indicated by same reference numerals. For clarity reasons, some elements may in some of the figures be without reference numerals.

A person skilled in the art will understand that the figures are just principal drawings. The relative proportions of individual elements may also be distorted.

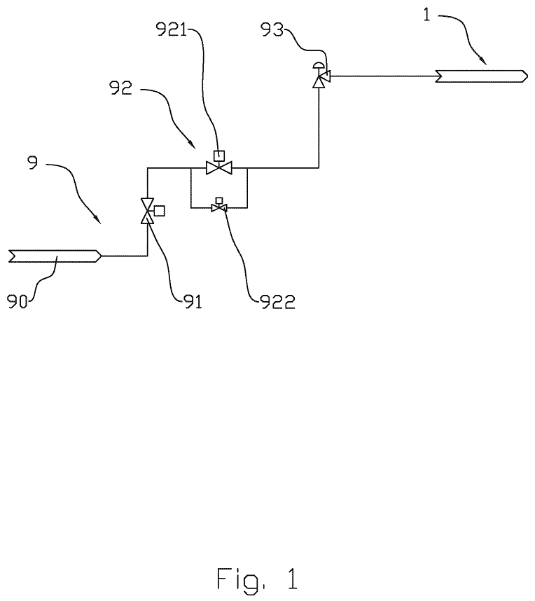

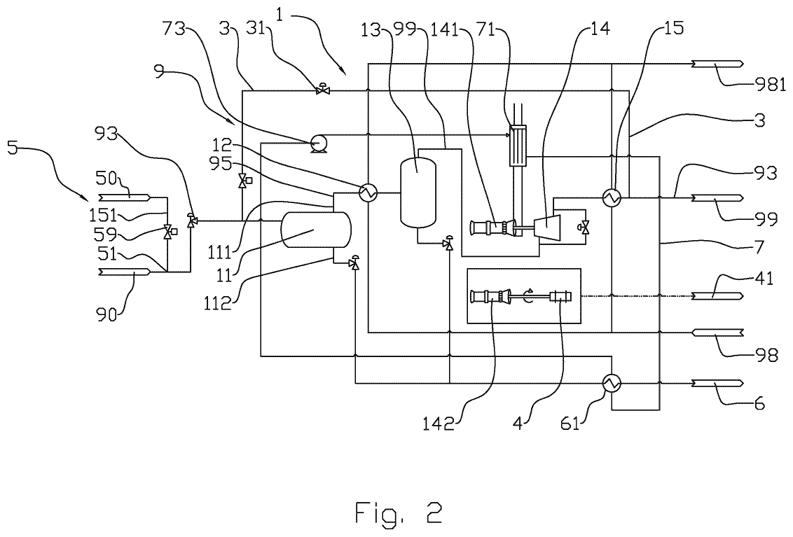

FIG. 1 discloses a conventional valve arrangement in a raw wellfluid flowline 9 for a gas 90 from gas wells (not shown) to a gas processing plant 1 (see FIG. 2). The raw wellfluid flowline 9 comprises an emergency safety valve 91 upstream of an inlet process safety valve 92. The process safety valve 92 is shown as two process safety valves 921, 922 arranged in parallel. A gas pressure reducing valve 93, also termed a raw wellfluid choke valve 930, is positioned downstream to the process safety valve 92 to reduce the gas pressure from an arrival pressure to a separator operating pressure. The pressure is reduced in an isenthalpic process and the energy is converted into no longer useful internal energy in the gas. The gas 90 in the raw wellfluid flowline 9 flows thereafter at the desired separator operating pressure into the gas processing plant 1 for subsequent treatment.

In a non-limiting example, the arrival pressure may be 150 Bar and the gas 90 from the gas wells may hold a temperature of 40° C. Gas flow may be 10 Msm3/d. The separator operating pressure may be 80 Bar and the gas 90 may hold 21° C.

FIG. 2 discloses a simplified conventional arrangement of the gas processing plant 1. The gas processing plant 1 conditions the well gas 90 to a gas of export quality 99. The gas 90 at the desired separator operating pressure enters the inlet separator 11. Condensate and aqueous liquids are separated from the gas 90 in the inlet separator 11 and a gas scrubber 13 to obtain export quality gas 99. The inlet separator 11 comprises a gas outlet 111 and a condensate outlet 112.

Aqueous liquids are routed from the inlet separator to a produced water treatment facility (not shown). Oil and condensate 6 leave the inlet separator 11 through the condensate outlet 112 and flows via an oil and condensate heater 61 to a treatment unit (not shown) and from there to either storage tanks (not shown) or an export line (not shown).

Wet gas 95 flows via the gas outlet 111 and further via a wet gas cooler 12 to a gas scrubber 13. From the gas scrubber 13 export quality gas 99 flows to an export gas compressor 14. The export gas compressor 14 is commonly driven by a first Brayton cycle gas turbine 141. The export quality gas 99 flows from the export gas compressor 14 through an aftercooler 15. The export quality gas 99 thereafter leaves the gas processing plant 1 through a gas export line 93.

Seawater 98 is commonly used as a cooling medium in the aftercooler 15 in an offshore gas processing plant 1. Seawater 98 may also be used as a cooling medium in the wet gas cooler 12. Used seawater 98 is returned to sea in a seawater return 981.

Electrical energy is supplied to a process plant power grid 41 by a main power generator 4. The main power generator 4 may be driven by a second Brayton cycle gas turbine 142.

It is common to have a Waste Heat Recovery unit (WHRU) 71 on the exhaust of Brayton cycle gas turbines 141, 142 to recuperate heat from the turbine exhaust and transfer this energy to a heating medium in a heat circulation loop 7 to cater for various heating needs in the gas processing plant 1 or other consumers (not shown). The heating medium conveys energy to the oil and condensate heater 61. The heat circulation loop 7 comprises a circulation pump 73.

At some time after the plateau production period of the gas field has passed, and production rate is reduced, the export gas compressor 14 must be operated outside of gas compressor's operational envelope, which may cause compressor surge. To avoid surge, gas of export quality 99 is recycled from downstream of the export gas compressor 14 to upstream of the inlet separator 11 through a recycle gas flow line 3. The recycle gas flow line 3 comprises a recycle gas control valve 31. The recycling of export quality gas 99 increases the gas rate passing through the export gas compressor 14.

MEG (monoethylene glycol) or methanol is optionally injected into the well gas 90 through an MEG injection line 151 to avoid forming of hydrates in the processing plant 1.

As mentioned, FIG. 2 is a simplified figure. The skilled person will know that such a process plant 1 comprises more valves and equipment than shown. In addition, there will be sensors and controllers (not shown) to operate the process plant 1 safely and efficiently.

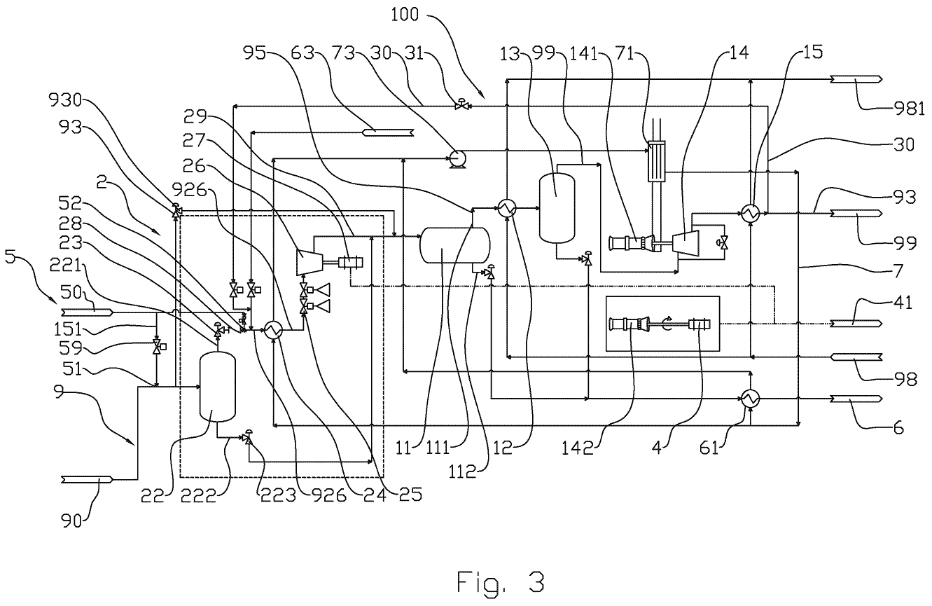

FIG. 3 discloses a gas processing plant 100 according to the invention. The gas processing plant 100 is provided with an energy harvesting assembly 2 shown within the stippled rectangle. The energy harvesting assembly 2 comprises a raw wellfluid knock out drum 22 connected to the raw wellfluid flowline 9. The raw wellfluid knock out drum 22 is fluidly connected to a turboexpander 26 by a turboexpander feed gas line 926. The raw wellfluid knock out drum 22 is provided with a gas outlet 221 for gas and a liquid outlet 222. The gas outlet 221 is shown connected to a turboexpander feed gas regulation valve 23 which is a high-capacity choke valve. The well gas 90 flows through the raw wellfluid knock out drum 22, thereafter within the turboexpander feed gas line 926 through the turboexpander feed gas regulation valve 23 and an optional turboexpander feed gas heater 24, to fast-acting turbine shut off valve(s) 25 and thereafter into the turboexpander 26. The turboexpander 26 is connected to a generator 27. After passing the turboexpander 26, the well gas 90 is fed into the gas raw wellfluid flowline 9 downstream of the raw wellfluid bypass choke valve 930 and upstream of the inlet separator 11.

In an alternative embodiment (not shown), a the turboexpander feed gas regulation valve 23 may be positioned upstream of the raw wellfluid knock out drum 22.

The separated liquid is contained within the raw wellfluid knock out drum 22. The liquid level is controlled by level control valve(s) 223. The liquid leaves the raw wellfluid knock out drum 22 through the liquid outlet 222, bypasses the turboexpander 26 and enters the raw wellfluid flowline 9 on the downstream side of the turboexpander 26 and is shown in the FIG. 3 to enter upstream of the inlet separator 11.

The gas pressure is reduced in a near isentropic process over the turboexpander 26. This means that the gas temperature downstream of the turboexpander 26 will be significantly lower compared to the gas temperature downstream of an ordinary choke valve operating at an isenthalpic process at the same conditions. In a non-limiting example, the arrival pressure may be 150 Bar and the gas 90 from the gas wells may hold a temperature of 40° C. Gas flow may be 10 Msm3/d. The separator operating pressure after the turboexpander 26 may be 80 Bar and the gas 90 may hold −0.5° C.

An export gas energy regeneration line 30 recycles export quality gas 99 from downstream the export gas compressor 14 to upstream the turboexpander 26. The recycled export quality gas 99 enters a turboexpander feed gas line 926 upstream the turboexpander 26.

In one embodiment of the invention a recycle gas flow 63 from re-compressors (not shown) is fed into the turboexpander feed gas line 926 upstream of the turboexpander 26. The re-compressors are recuperating gas from the oil and condensate 6.

In one embodiment of the invention, abundance of heat energy from the waste heat recovery unit 71 is transported by the heating medium to the optional turboexpander feed gas heater 24 of the energy harvesting assembly 2. The heating medium is flowing back to the waste heat recovery unit 71. The heating medium is flowing in the dedicated heat circulation loop 7.

This heat energy will expand the gas 90 within the turboexpander feed gas line 926, thus increasing the energy that may be produced by the turboexpander 26. Even if subsequent cooling is necessary downstream of the turboexpander 26 to counteract the heating effect, this will result in a significant net energy surplus. Additionally, if the gas 90 is heated above gas hydrate equilibrium temperature, this may remove the need for injecting monoethylene glycol or methanol to avoid gas hydrates.

Electrical energy produced by the generator 27 is fed into the process plant power grid 41. The generator 27 provides redundancy in the process plant power grid 41 in case the main power generator 4 is out for maintenance. The generator 27 reduces the need for electrical energy from the main power generator 4 and may even substitute the electrical energy from the main power generator 4.

In one embodiment a check valve 28 is mounted downstream to the turboexpander feed gas regulation valve 23 to avoid reverse flow when well gas 90 is routed via the raw wellfluid bypass choke valve 930. In this embodiment the turboexpander 26 may produce power solely by the recycled export quality gas 99 flowing in the export gas energy regeneration line 30 from the export gas compressor 14. In an alternative embodiment the turboexpander 26 may produce power solely by utilizing the recycle gas flow 63 from the re-compressors. In a further alternative embodiment, the turboexpander 26 may produce power by combining export quality gas 99 and/or the recycle gas flow 63 from the re-compressors and well gas 90.

Advantageously, the recycle gas flow 63 from the re-compressors may be fed into the raw wellfluid flowline 9 upstream of the raw wellfluid knock out drum 22 (not shown) to condition the recycle gas flow 63 to meet design limits of the turboexpander 26. In this embodiment, a separate check valve (not shown) may be mounted upstream of the raw wellfluid knock out drum 22 to avoid backflow of the recycle gas flow 63 from the re-compressors when well gas 90 is routed via the raw wellfluid bypass choke valve 930.

In one embodiment the gas processing plant 100 comprises an injection system 5 for injection of monoethylene glycol, methanol or other suitable compounds for preventing gas hydrate formation in the raw wellfluid flowline 9. The injection system 5 comprises a reservoir 50 and necessary valves 59 and pump(s) (not shown). The injection system 5 may comprise a first injector 51 between the emergency safety valve 91 and the process safety valve 92. The injection system 5 may comprise a second injector 52 downstream of the check valve 28.

Due to the substantial cooling effect of the turboexpander 26, the inlet separator 11 will be operated at a low temperature. In one embodiment of the invention this cooling effect may be further exploited by facilitating temperature exchange between the cooled gas and/or condensate with other hot process media to reduce plant power consumption. One non-limiting example of this embodiment may be that cool condensate must be heated to flash associated gas in a condensate treatment plant (not shown). It may be convenient to exchange temperature with other hot process media that requires cooling.

The turboexpander 26 are usually limited to operating at maximum 1-2 weight % liquid in the gas 90. Therefore, the raw wellfluid knock out drum 22 is required for conditioning the gas 90 to meet design limits of the turboexpander 26.

The turbine shut off valve(s) 25 may be required in order to trip the gas flow to the turboexpander 26 to avoid overspeed, for example if a sudden load loss on the generator 27 occurs. The turbine shut off valve(s) 25 may be required in order to trip the gas flow through the turboexpander 26 in case of overpressure in a downstream segment due to, but not limited to, inadvertent valve operation or other process upsets. The turbine shut off valve(s) 25 may be of HIPPS valve classification (High Integrity Pressure Protection System). To accommodate requirements with high integrity instruments both speed sensors (not shown) and pressure sensors that initiates HIPPS valve trip may be triple redundant with a 2 out of 3 rotation.

The optional turboexpander feed gas heater 24 is heated via the processing plants 100 heat circulation loop 7. The gas temperature downstream the turboexpander 26 may be controlled by a standard control scheme to fit the processing requirements.

Ordinary production during plateau production period Plateau production is the period of a gas field's lifetime where there is excess energy in the reservoir to maintain the plateau production flowrate. All well gas 90 is routed through the turboexpander 26. Excess heat recovered from one or more waste heat sources can be exploited to heat the gas 90 by the optional turboexpander feed gas heater 24. This may increase the recoverable energy in the turboexpander 26. The turboexpander feed gas heater 24 may also be used to control the gas temperature downstream to the turboexpander 26.

Furthermore, during the plateau production period, the main power generator 4 may be out for maintenance. In a known gas processing plant 1 this would require a production shutdown due to power shortage. Embodiments of the invention allow the export gas compressor 14 to be ramped up to recycle gas of export quality 99 to the turboexpander 26 through the export gas energy regeneration line 30 and increase the power production sufficiently to maintain production while maintenance is performed on the main power generator 4. In addition, the recycle flow 63 of gas from at least one re-compressor may be fed into the turboexpander feed gas line 926 upstream of the turboexpander 26 to further support the power production.

### Production During Declining Production Period

The declining production period is the period of a gas field's lifetime where there is not sufficient energy in the reservoir to maintain the plateau production flowrate. Therefore, production flowrate reduces as a function of time and the well fluid may be bypassing the turboexpander 26 to minimize pressure losses. As the production flowrate declines the export gas compressor 14 and/or re-compressor(s) is/are at some point operated below their operational envelope. Therefore, it is necessary to recycle gas of export quality 99 and/or wet gas 95 from the re-compressor(s) in order to maintain the export gas compressor 14 and/or re-compressor(s) within their operational envelope. The alternative may be to execute an expensive and cumbersome re-bundling modification of the export gas compressor 14 and/or re-compressor(s). In any case this entails a loss of efficiency. Embodiments of the invention allow the export gas compressor 14 to recycle gas of export gas quality 99 and/or the re-compressor(s) to recycle wet gas 95 to the turboexpander 26 and thus indirectly becoming power production generators while at the same time operating within their operational envelopes.

It should be noted that the abovementioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise”, and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

What is claimed is:

1. A gas processing plant (100), wherein the gas processing plant (100) comprises at least:
a raw wellfluid flow line (9);
a raw wellfluid bypass choke valve (930);
an inlet separator (11); and
an export gas compressor (14),
wherein the gas processing plant (100) comprises an energy harvesting assembly (2), wherein the energy harvesting assembly (2) comprises:
a raw wellfluid knock out drum (22) connected to the raw wellfluid flow line (9);
a turboexpander (26) connected to a generator (27); and
a conduit (29) between the turboexpander (26) and the inlet separator (11),
wherein the conduit (29) is connected to the inlet separator (11) downstream of the raw wellfluid bypass choke valve (930),
and an export gas energy regeneration line (30) is adapted to recycle an export quality gas (99) from downstream the export gas compressor (14) to upstream of the turboexpander (26).

2. The gas processing plant (100) of claim 1, wherein the energy harvesting assembly (2) comprises a turboexpander feed gas heater (24) upstream of the turboexpander (26).

3. The gas processing plant (100) of claim 2, wherein the turboexpander feed gas heater (24) is fluidly connected to a waste heat recovery unit (71) via a heat circulation loop (7).

4. The gas processing plant (100) of claim 1, wherein a separated liquid is contained within the raw wellfluid knock out drum (22), the raw wellfluid knock out drum (22) is provided with a liquid outlet (222), and the liquid outlet (222) is fluidly connected to the raw wellfluid flow line (9) on the downstream side of the turboexpander (26).

5. The gas processing plant (100) of claim 1, wherein at least one re-compressor is fluidly connected to a turboexpander feed gas line (926) upstream of the turboexpander (26).

6. The gas processing plant (100) of claim 1, wherein a turboexpander feed gas regulation valve (23) is positioned upstream of the turboexpander (26).

7. The gas processing plant (100) of claim 6, wherein the turboexpander feed gas regulation valve (23) is positioned between a gas outlet (221) of the raw wellfluid knock out drum (22) and the turboexpander (26).

8. The gas processing plant (100) of claim 6, wherein a check valve (28) is positioned downstream of the turboexpander feed gas regulation valve (23).

9. The gas processing plant (100) of claim 1, wherein the gas processing plant (100) comprises an injection system (5) for injection of monoethylene glycol, methanol or other suitable compounds for preventing gas hydrate formation in the raw wellfluid flow line (9).

10. The gas processing plant (100) of claim 9, wherein the injection system (5) comprises an injector (52) downstream of the check valve (28).

11. A method for recuperating energy in a gas processing plant (100) during a declining production period, wherein the method comprises to:
provide the gas processing plant (100) of claim 1; and
recycle export quality gas (99) from downstream of the export gas compressor (14) to upstream of the turboexpander (26).

12. The method of claim 11, wherein the method comprises to heat the gas of export quality (99) by the turboexpander feed gas heater (24).

13. The method of claim 11, wherein the method comprises to utilize a recycle gas flow (63) from at least one re-compressor into the turboexpander feed gas line (926) upstream of the turboexpander (26).

14. A method for recuperating energy in a gas processing plant (100) during a plateau production period, wherein the method comprises to:
provide the gas processing plant (100) of claim 1;
close a raw wellfluid bypass choke (93, 930) on the raw wellfluid flow line (9); and
route all well gas (90) through the turboexpander (26).

15. The method of claim 14, wherein the method comprises to heat the well gas (90) by the heater (24).

16. The method of claim 14, wherein the method comprises to utilize a recycle gas flow (63) from at least one re-compressor into the turboexpander feed gas line (926) upstream of the turboexpander (26).

17. The method of claim 14, wherein the method comprises to recycle the gas of export quality (99) from downstream the export gas compressor (14) to upstream of the turboexpander (26).
